(19) United States
(12) Patent Application Publication
(10) Pub. No.: US 2008/0054852 A1
(43) Pub. Date: Mar. 6, 2008

(54) Charging system and charging method

(75) Inventors: Satoshi Kazuta, Tachikawa-shi (JP); Masaaki Nishiura, Machida-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/896,197

(22) Filed: Aug. 30, 2007

(30) Foreign Application Priority Data
Aug. 31, 2006 (JP) 2006-235319

(51) Int. Cl. H02J 7/02; H01M 10/44

(52) U.S. Cl. 320/137

(57) ABSTRACT

According to one embodiment, a charging system comprises a charging device including a converter for converting a commercial AC current into a DC current and a switching unit for supplying the DC current from the converter through a wiring path to exterior to open and close the wiring path according to a detection signal, and an information device including a battery to be charged to which the DC current from the charging device is supplied through the wiring path of the charging device, an abnormality detector for, when an abnormality of the DC current is detected, supplying the detection signal to the switching unit of the charging device, and an information processor for processing information when the information processor is supplied with a power source from the battery to be charged.

### CROSS-REFERENCE TO RELATED APPLICATIONS

This application is based upon and claims the benefit of priority from Japanese Patent Application No. 2006-235319, filed Aug. 31, 2006, the entire contents of which are incorporated herein by reference.

### BACKGROUND

1. Field

One embodiment of the invention relates to a charging system and method for charging a power source of an information processor.

2. Description of the Related Art

Many information devices have been developed and are now in common. Of those information devices, the information device reduced in size is used as a portable device and increases in their number. In many cases, the size-reduced information device has a charging function, and a battery contained in the information device is charged by a charger in home or the like before the device is used outdoors. In this type of information device, however, the charging time is longer than an expected time. A user must charge the information device for several hours before he/she goes to work, for example. This puts much strain on the user.

Jpn. Pat. Appln. KOKAI Publication No. 08-33224 discloses such a technique that to shorten a charging time, a constant voltage charging operation starts at the instant that a battery voltage exactly reaches a preset voltage level.

It is not allowed that a too large switching element is used for the switching element, contained in the portable information device, for stopping a charging operation when an abnormality is detected. When the switching element that may be contained in the information device is used, it is not allowed to extremely increase the charging current value. Therefore, it is impossible to remarkably reduce the charging time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an exemplary arrangement of an information processor with a power source and a charger according to an embodiment of the present invention;

FIG. 2 is a diagram showing an exemplary external appearance of a portable playback device and a charger according to the embodiment of the invention;

FIG. 3 is a diagram showing an exemplary external appearance of a portable television and a charger according to the embodiment of the invention;

FIG. 4 is a diagram showing an exemplary external appearance of a mobile phone and a charger according to the embodiment of the invention;

FIG. 5 is a flow chart showing an exemplary overvoltage protection process for a power source of the information processor according to the embodiment of the invention;

FIG. 6 is a flow chart showing an exemplary overdischarging current protection process for the power source of the information processor according to the embodiment of the invention;

FIG. 7 is a flow chart showing an exemplary overdischarge protection process for the power source of the information processor according to the embodiment of the invention;

FIG. 8 is a flow chart showing an exemplary load short-circuit protection process for the power source of the information processor according to the embodiment of the invention;

FIG. 9 is a flow chart showing an exemplary overcharging current protection process for the power source of the information processor according to the embodiment of the invention; and

FIG. 10 is a flow chart showing an exemplary operation of a control logic circuit in the information processor according to the embodiment of the invention.

### DETAILED DESCRIPTION

Various embodiments according to the invention will be described hereinafter with reference to the accompanying drawings. In general, according to one embodiment of the invention, a charging system comprising: a charging device including a converter which converts a commercial AC current into a DC current, and a switching unit which supplies the DC current from the converter through a wiring path to exterior to open and close a wiring path according to a detection signal supplied; and an information device including a battery to be charged to which the DC current from the charging device is supplied through the wiring path of the charging device, an abnormality detector which, when an abnormality of the DC current is detected, supplies the detection signal to the switching unit of the charging device, and an information processor which processes information when the information processor is supplied with a power source from the battery to be charged.

One embodiment of the invention provides a charging system and method which enable high speed charging by using a large current for a charging DC current.

There is provided, as exemplary means for solving the problem, a charging system including: a charging device (42) including a converter (26) for converting a commercial AC current into a DC current to output the DC current and a switching unit (27) which supplies the DC current from the converter through a wiring path to exterior to open and close a wiring path according to a detection signal; and an information device (40) including a battery (16) to be charged to which the DC current from the charging device is supplied through the wiring path of the charging device, an abnormality detector (10) for, when an abnormality of the DC current is detected, supplying the detection signal to the switching unit of the charging device; and an information processor (21, 22) for processing information when the information processor is supplied with a power source from the battery to be charged.

As just mentioned, a switching element for stopping current feed when an abnormality occurs is incorporated into the charging device 42. As a result, a large switching element may be used for the switching element. The large switching element can supply a large current to a battery to be charged in the information device, resulting in realization of high speed charging.

Embodiments of the invention will be described in detail with reference to the accompanying drawings.

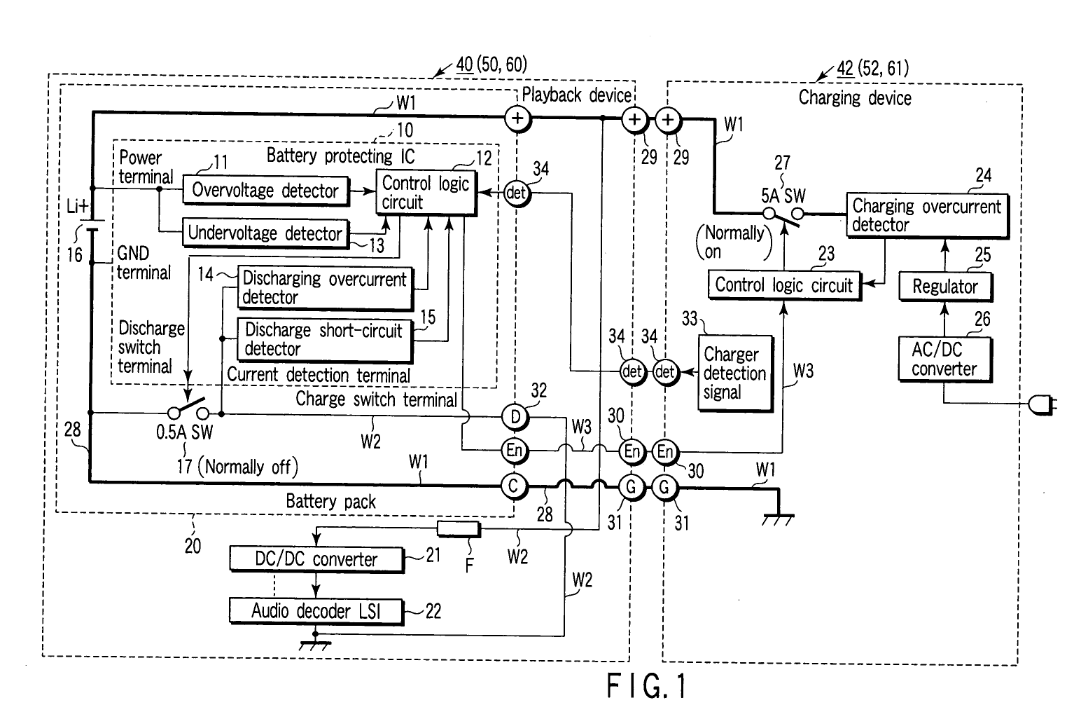

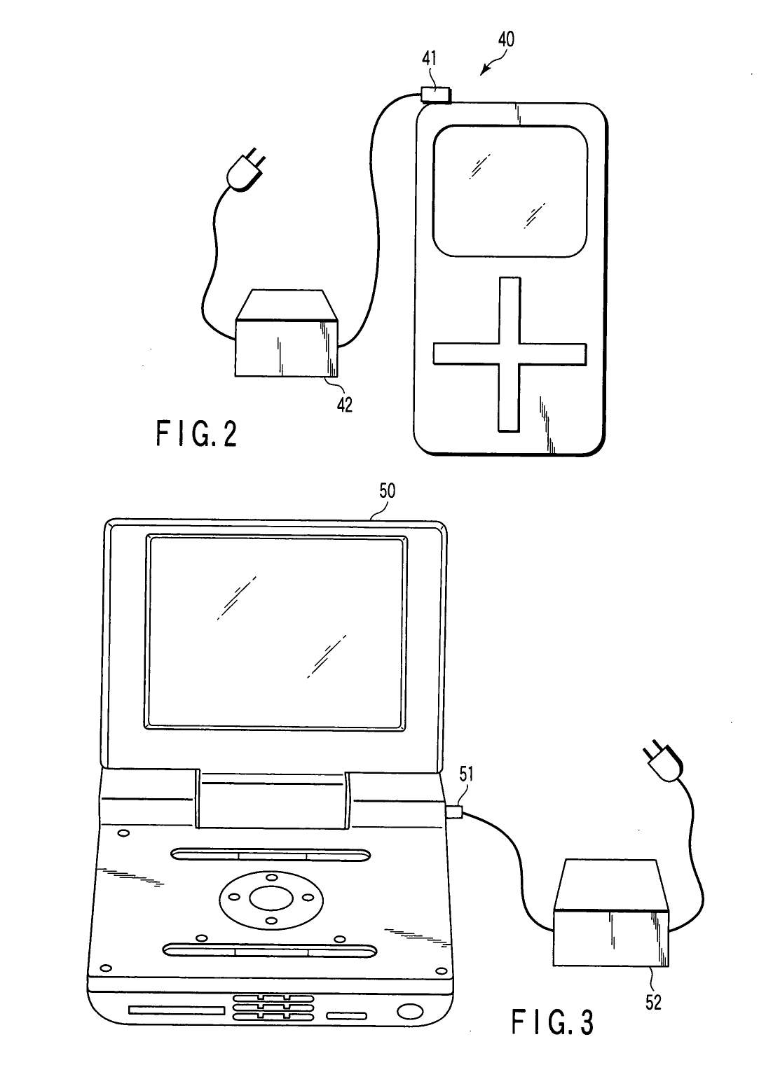

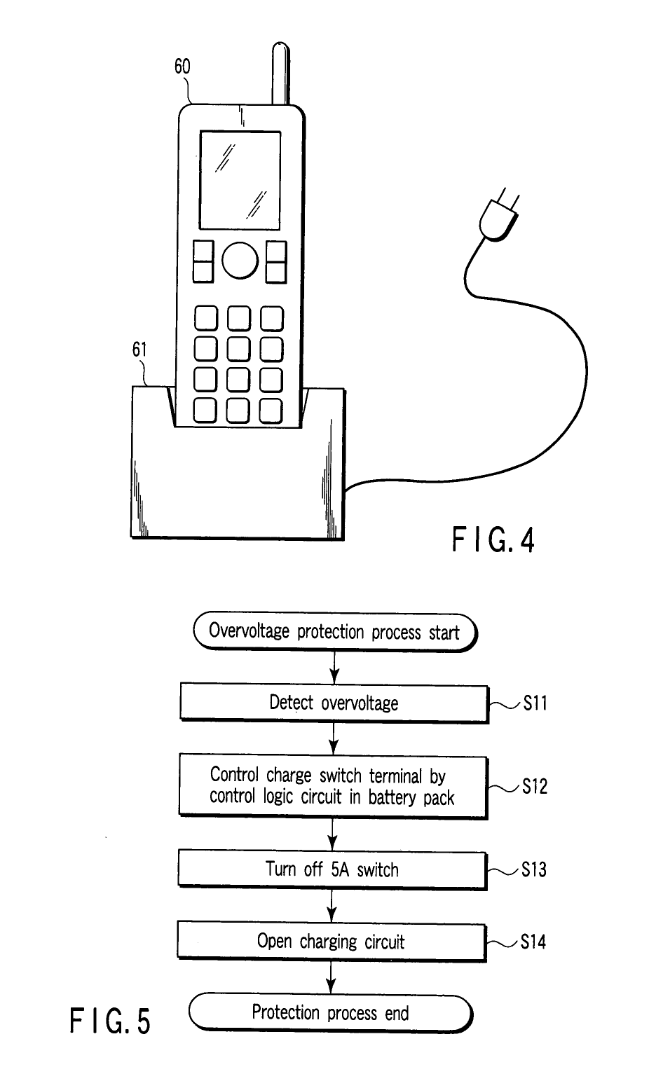

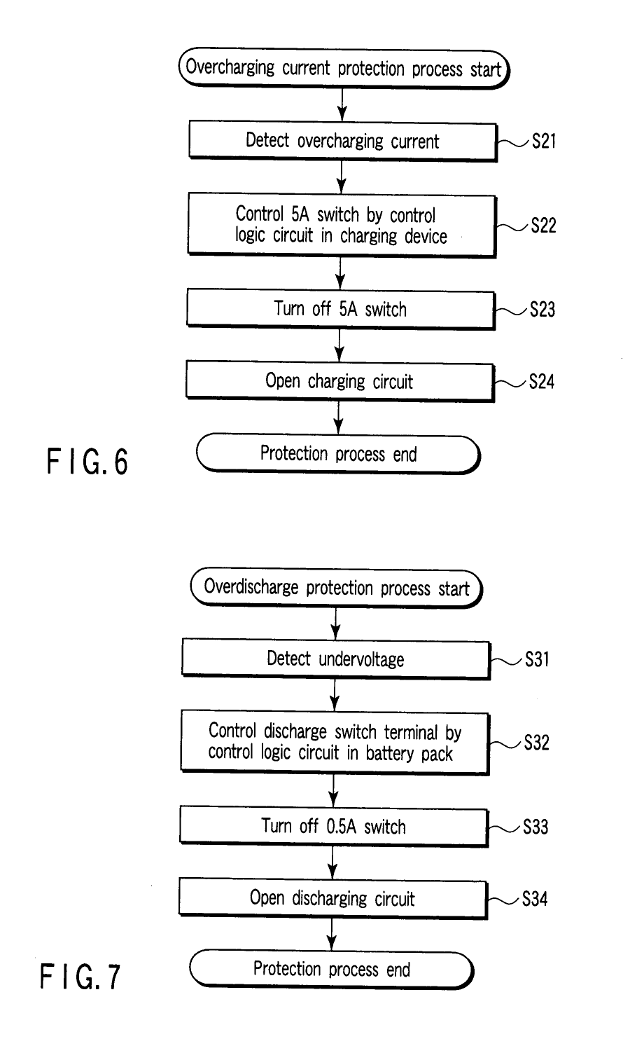

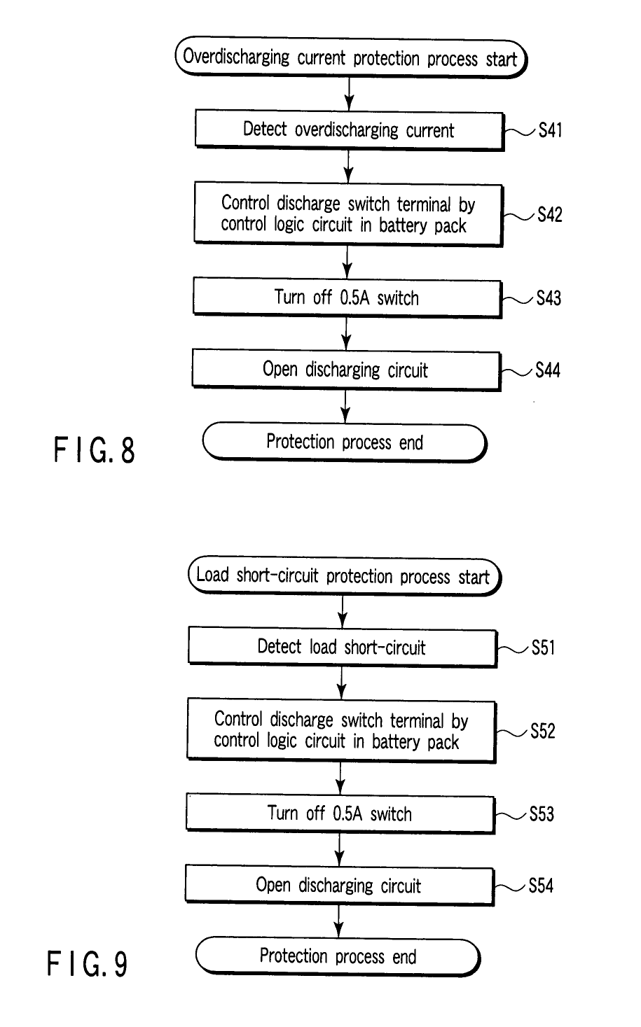

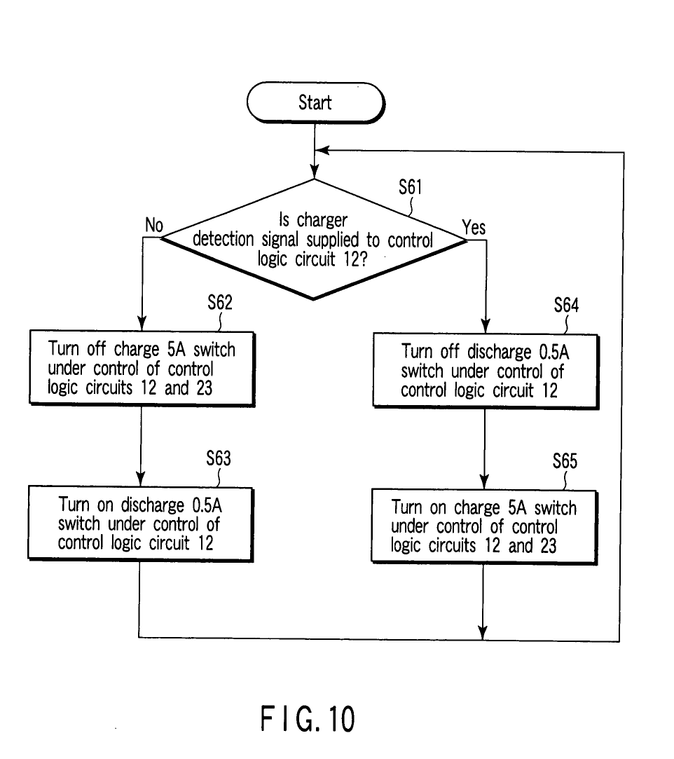

FIG. 1 is a block diagram showing an exemplary arrangement of an information processor with a power source and a charger according to an embodiment of the present invention. FIG. 2 is a diagram showing an exemplary external appearance of a portable playback device and a charger according to the embodiment of the invention. FIG. 3 is a diagram showing an exemplary external appearance of a portable television and a charger according to the embodiment of the invention. FIG. 4 is a diagram showing an exemplary external appearance of a mobile phone and a charger according to the embodiment of the invention. FIG. 5 is a flow chart showing an exemplary overvoltage protection process for a power source of the information processor according to the embodiment of the invention. FIG. 6 is a flow chart showing an exemplary overdischarging current protection process for the power source of the information processor according to the embodiment of the invention. FIG. 7 is a flow chart showing an exemplary overdischarge protection process for the power source of the information processor according to the embodiment of the invention. FIG. 8 is a flow chart showing an exemplary load short-circuit protection process for the power source of the information processor according to the embodiment of the invention. FIG. 9 is a flow chart showing an exemplary overcharging current protection process for the power source of the information processor according to the embodiment of the invention. FIG. 10 is a flow chart showing an exemplary operation of a control logic circuit in the information processor according to the embodiment of the invention.

<Charging System>

A charging system as an embodiment of the invention will be described in detail with reference to the accompanying drawings.

(Configuration)

A charging system as an embodiment of the invention, as shown in FIG. 1, is generally composed of a playback device 40 (50, 60) and a charging device 42 for charging a battery 16 to be charged in the playback device 40.

The playback device 40, as shown in FIG. 1, further has a battery back 20. The battery back 20 includes a battery protecting IC 10, a lithium battery 16 to be connected to a large-current positive potential terminal 29 through a large-current wiring w1, and a discharge 0.5 A switch 17 connected to the battery 16 to be charged. The discharge 0.5 A switch 17 is preferably of a normally off type in order to protect circuits 21 and 22 in the playback device 40 against the charging large current.

The battery protecting IC 10 includes an overvoltage detector 11 for detecting an abnormality in the large-current wiring w1, an undervoltage detector 13 for detecting an abnormality in the large-current wiring w1, a control logic circuit 12 for processing those abnormality detection signals, a discharging overcurrent detector 14 for detecting an abnormality in the wiring for discharging, and a discharge short-circuit detector 15 which also detects an abnormality in the wiring for discharging.

The playback device 40 includes a DC/DC converter 21 for receiving a power source through an overcurrent preventing fuse F from the battery pack 20, and an audio decoder LSI 22 for playing back a voice signal by decoding it, and plays back a desired voice signal.

The charging device 42 (52, 61) contained in the charging system of the embodiment additionally includes an AC/DC converter 26 for converting a commercial AC current into a DC current, and a regulator 25 for keeping the DC current at a fixed current value. The charging device 42 (52, 61) further includes a charging overcurrent detector 24 and a control logic circuit 23. The charging overcurrent detector 24 detects a charging overcurrent from the DC current output from the regulator 25. The control logic circuit 23 receives detection signals from the charging overcurrent detector 24 and a detection signal terminal 30, determines whether or not an abnormality occurs on the basis of the detection signals, and opens or closes a 5 A switch 27 to avoid the abnormality. Furthermore, the charging device 42 (52, 61) includes a ground terminal 31 by which the charging device and the playback device 40 use the same set potential. The charge 5 A switch 27 is preferably of a normally on type in order to supply a power source to the playback device 40.

It is noted that in the charging system of the invention, a large capacity wiring of 5 A is used for the large-current wiring w1. The 5 A switch 27 is a large switch of about 3 centimeter square. Accordingly, it is not installed in the playback device 40 (50, 60) as a mobile device for which the size and weight reduction is required.

In the present embodiment, the 5 A switch 27 which operates in response to the abnormality detection signal, which has been installed in the playback device 40 (50, 60) of which the size reduction is essential, is installed in the charging device 42 (52, 61) of which the size reduction is less required.

The capacity (cf. 5A) of the wiring w1 between the switching unit of the charging device and the battery to be charged in the information device is larger than that (cf. 0.5 A) of a wiring w2 between the battery to be charged and the information processor.

A current (cf. 5A) flowing between the switching unit of the charging device and the battery to be charged in the information device is larger in value than that (cf. 0.5A) flowing between the battery to be charged and the information processor. This enables a high speed charging.

The first connection terminal 29, which is positioned between the playback device and the charging device and is provided for connecting the switching unit of the charging device and the battery to be charged of the playback device, is larger in capacity than the detection signal terminal 30 and a second connection terminal 32, which is positioned between the playback device and the charging device and is provided for connecting the battery to be charged and the information processor.

The charging device 42 contains a charger detection signal 33, which is supplied to the control logic circuit 12 contained in the battery protecting IC 10 of the playback device 40, through the connection terminals 34. Whether or not the main body of the playback device 40 is reliably electrically connected to the charging device 42 is determined depending on whether or not the charger detection signal 33 is supplied to the control logic circuit 12.

(High Speed Charging)

It is estimated that a charging speed increases inversely proportional to a charging current value. Specific examples are given below.

For the battery capacity of 10 Ah:

Charging time=1 hour when charging current=10 A.

Charging time=20 hours when charging current=500 mA.

For the battery capacity of 1 Ah:

Charging time=6 minutes when charging current=10 A.

Charging time=2 hours when charging current=500 mA.

For the battery capacity of 500 mh:

Charging time=3 minutes when charging current=10 A.

Charging time=1 hour when charging current=500 mA.

As seen from those examples, high speed charging considerably lessens the mental strain put on the user when the battery is charged.

(Charging System Applications)

The charging system thus arranged will be applied to any application where the potable electronic device is used in connection with the charger. The charging system is applicable to an MP3 player as shown in FIG. 2, for example. In FIG. 2, the playback device 40 may be charged from the charging device 42 containing a large current switch through a connection terminal 41.

The charging system may also be applied to a portable television device 50. In FIG. 3, the portable television device 50 may be charged from a charger 52 containing a large current switch through a connection terminal 51.

Further, the charging system may be applied to a mobile phone 60 as shown in FIG. 4. In FIG. 4, the mobile phone 60 may be charged from the charger 52 containing a large current switch.

(Operation)

A protecting operation of the charging system thus arranged will be described with reference to flow charts. A DC current into which the AC/DC converter 26 converts a commercial AC power source received is kept at a constant current value by the regulator 25 and is supplied to the charging overcurrent detector 24. If no abnormality occurs, a DC current of 5 A, for example, is fed to the lithium battery 16 through the 5 A switch 27 and the first connection terminal 29.

At this time, as shown in a flow chart of FIG. 5, when the overvoltage detector 11 detects an overvoltage on the large-current wiring w1 (Step S11), a detection signal is supplied from the control logic circuit 12 in the battery pack to the control logic circuit 23 through the detection signal terminal 30 (Step S12) to turn off the SA switch 27 (Step S13). As a result, the charging circuit is opened (Step S14) to complete the charging circuit protection process.

As shown in a flow chart of FIG. 6, when the charging overcurrent detector 24 detects an overcurrent on the large-current wiring w1 (Step S21), the control logic circuit 12 in the battery pack sends a detection signal to the control logic circuit 23 (Step S22) to turn off the 5 A switch 27 (Step S23). As a result, the charging circuit is opened (Step S24) to complete the charging circuit protection process.

As shown in a flow chart of FIG. 7, when the undervoltage detector 13 detects an undervoltage on the large-current wiring w1 (Step S31), the control logic circuit 12 in the battery pack sends a detection signal to the control logic circuit 12 (Step S32) to turn off the 0.5 A switch 17 (Step S33). As a result, the charging circuit is opened (Step S34) to complete the charging circuit protection process.

As shown in a flow chart of FIG. 8, when the discharging overcurrent detecting circuit 14 detects a discharging overcurrent on the wiring w2 (Step S41), a detection signal is supplied from the control logic circuit 12 in the battery pack to the control logic circuit 12 (Step S42) to turn off the 0.5 A switch 17 (Step S43). As a result, the discharging circuit is opened (Step S44) to complete the discharging circuit protection process.

As shown in a flow chart of FIG. 9, when the discharge short-circuit detector 15 detects a discharge short-circuit on the wiring w2 (Step S51), the control logic circuit 12 in the battery pack supplies a detection signal to the control logic circuit 12 (Step S52) to turn off the 0.5 A switch 17 (Step S53). As a result, the charging circuit is opened (Step S54) to complete the charging circuit protection process.

As shown in a flow chart of FIG. 10, the control logic circuit 12 determines whether or not the charger detection signal 33 is supplied to the control logic circuit 12 of the battery protecting IC 10 (Step S61). When the determination result is negative, a control signal is supplied from the control logic circuit 12 through the detection signal terminal 30 to the control logic circuit 23 in the charging device 42. In turn, the control logic circuit 23 supplies a control signal to turn off the charge 5 A switch 27 of the normally on type (Step S62). At the same time, the control logic circuit 12 turns on the discharge 0.5 A switch 17 of the normally off type on the fact that the charger detection signal 33 is not supplied to the control logic circuit 12 of the battery protecting IC 10 to thereby discharge the battery (Step S63).

When the step S61 detects that the charger detection signal is supplied of the control logic circuit 12, a control signal is supplied from the control logic circuit 12 through the detection signal terminal 30 to the control logic circuit 23 of the charging device 42. The control logic circuit 12 turns off the discharge 0.5 A switch 17 of the normally off type on the fact that the charger detection signal 33 is supplied to the control logic circuit 12 of the battery protecting IC 10 (Step S64). Further, the control logic circuit 23 supplies a control signal in order to turn on the charge 5 A switch 27 of the normally on type to thereby charge the battery (Step S65).

In this way, the discharge 0.5 A switch 17 and the charge 5 A switch 27 are controlled according to the charger detection signal 33 derived from the charging device 42, whereby more reliable and safety charging/discharging operation is ensured.

The charging system of the embodiment has the protection function as described above. When the 5 A switch 27 to realize the protection function or the like is provided in the charging device, the large-current based high speed charging may be applied to the portable electronic device.

It should be understood that those persons skilled in the art could realize the present invention on the basis of various embodiments mentioned above and will readily modify those embodiments, and further that the invention will be implemented without any inventive ability. Therefore, it should also be understood that the present invention involves the principles disclosed and a technical concept having a broad scope within which no contradiction with the novel characteristics occurs.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charging system comprising:
a charging device including a converter which converts a commercial AC current into a DC current, and a switching unit which supplies the DC current from the converter through a wiring path to exterior to open and close a wiring path according to a detection signal supplied; and
an information device including a battery to be charged to which the DC current from the charging device is supplied through the wiring path of the charging device, an abnormality detector which, when an abnormality of the DC current is detected, supplies the detection signal to the switching unit of the charging device, and an information processor which processes information when the information processor is supplied with a power source from the battery to be charged.

2. The charging system according to claim 1, wherein a capacity of a wiring between the switching unit of the charging device and the battery to be charged in the information device is larger than that of a wiring between the battery to be charged and the information processor.

3. The charging system according to claim 1, wherein a current flowing between the switching unit of the charging device and the battery to be charged in the information device is larger in value than that flowing between the battery to be charged and the information processor.

4. The charging system according to claim 1, wherein a first connection terminal, which is positioned between the playback device and the charging device and is provided for connecting the switching unit of the charging device and the battery to be charged of the information device, is larger in capacity than a second connection terminal, which is positioned between the playback device and the charging device and is provided for connecting the battery to be charged and the information processor.

5. The charging system according to claim 1, wherein the information device is a playback device which plays back a video or voice signal.

6. The charging system according to claim 1, wherein the information device is a portable television device which receives a broadcasting signal and reproduces the broadcasting signal.

7. The charging system according to claim 1, wherein the information device is a mobile phone which communicates with an external base station.

8. A method for charging a power source of an information device by using a charging device, comprising:
converting a commercial AC current into a DC current by the charging device;
outputting the converted DC current through a switching unit contained in the charging device;
charging a battery to be charged with the DC current supplied thereto in the information device; and
when an abnormality is detected in the DC current, supplying a detection signal to the switching unit in the charging device to thereby stop the supply of the DC current.

9. The charging method according to claim 8, wherein a capacity of a wiring between the switching unit of the charging device and the battery to be charged in the information device is larger than that of a wiring between the battery to be charged and an information processor which processes information when the information processor is supplied with a power source from the battery to be charged contained in the information device.

10. The charging method according to claim 8, wherein a current flowing between the switching unit of the charging device and the battery to be charged in the information device is larger in value than that flowing between the battery to be charged and an information processor which processes information when the information processor is supplied with a power source from the battery to be charged contained in the information device.

11. The charging method according to claim 8, wherein a first connection terminal, which is positioned between the playback device and the charging device and is provided for connecting the switching unit of the charging device and the battery to be charged of the information device, is larger in capacity than a second connection terminal, which is positioned between the playback device and the charging device and is provided for connecting the battery to be charged and an information processor contained in the information device, the information processor processing information when the information processor is supplied with a power source from the battery to be charged.

12. The charging method according to claim 8, wherein the information device is a playback device which plays back a video or voice signal.

13. The charging method according to claim 8, wherein the information device is a portable television which receives a broadcasting signal and reproduces the broadcasting signal.

14. The charging method according to claim 8, wherein the information device is a mobile phone which communicates with an external base station.
